(19) United States
(12) Patent Application Publication
(10) Pub. No.: US 2025/0350990 A1
(43) Pub. Date: Nov. 13, 2025

(54) WIRELESS COMMUNICATION METHOD AND DEVICE THEREOF

(71) Applicant: ZTE CORPORATION, Shenzhen (CN)

(72) Inventors: Jianqiang DAI, Shenzhen (CN); Bo DAI, Shenzhen (CN); Jun XU, Shenzhen (CN); Mengzhu CHEN, Shenzhen (CN)

(73) Assignee: ZTE CORPORATION, Shenzhen (CN)

(21) Appl. No.: 19/278,984

(22) Filed: Jul. 24, 2025

Related U.S. Application Data
(63) Continuation of application No. PCT/CN2023/086298, filed on Apr. 4, 2023.

(51) Int. Cl. H04W 24/10; H04L 27/26; H04W 72/231

(52) U.S. Cl. CPC H04W 24/10; H04L 27/26025; H04W 72/231

(57) ABSTRACT

A wireless communication method for use in a wireless terminal is disclosed. The method comprises receiving, from a wireless network node, configuration information associated with a measurement gap, triggering a measurement gap indication for adapting the measurement gap configured by the configuration information, and performing a measurement operation based on the adopted measurement gap.

### CROSS-REFERENCE TO RELATED PATENT APPLICATIONS

This application is a U.S. Continuation of International Application No. PCT/CN2023/086298, filed Apr. 4, 2023, incorporated herein by reference in its entirety.

### TECHNICAL FIELD

This document is directed generally to wireless communications, in particular to 5G communications and more particularly to 6G communications.

### BACKGROUND

When a certain condition is met, the UE may be handed overed to the neighbor cell. This is a mobility function in a network.

### SUMMARY

In a wireless communication system, a UE (user equipment) performs (inter-frequency) neighbor cell measurement(s) within a measurement gap, to assess communication quality in neighbor cell(s). Moreover, a BS (base station), e.g., gNB, configures the measurement gap and downlink signals, to allow the UE to perform the measurement(s) by receiving the downlink signals.

For example, the UE may move from a serving cell to a neighbor cell when the communication quality of the neighbor cell may be better than that of the serving cell. That is, when a certain condition is met, the UE may be handed overed to the neighbor cell. Note that the UE cannot perform the measurement(s) while transmitting or receiving data. In other words, the UE is configured not to perform data transmission or reception in the measurement gap.

FIG. 1 shows a schematic diagram of the measurement gap. In FIG. 1, a length of the measurement gap is 6 ms in every 40 ms time period. During the measurement gap, the UE performs the (inter-frequency) neighbor cell measurement(s). Note that the time domain resource within the measurement gap is not allowed to be scheduled for data (transmission or reception).

This document relates to methods, systems, and devices for configuring the measurement gap, and in particular to methods, systems, and devices for adapting the measurement gap.

The present disclosure relates to a wireless communication method for use in a wireless terminal. The method comprises:
receiving, from a wireless network node, configuration information associated with a measurement gap,
triggering a measurement gap indication for adapting the measurement gap configured by the configuration information, and
performing a measurement operation based on the adopted measurement gap.

Various embodiments may preferably implement the following features:

Preferably or in some embodiments, performing the measurement operation based on the adopted measurement gap comprises at least one of:
performing a measurement in the adopted measurement gap in a first period if the adopted measurement gap is not canceled in the first period, or
skipping a measurement in a second period, wherein the measurement gap is canceled after being adapted in the second period

Preferably or in some embodiments, the wireless communication method further comprises receiving, from the wireless network node, a network signaling of triggering the measurement gap indication.

Preferably or in some embodiments, the network signaling is a media access control element.

Preferably or in some embodiments, the wireless communication method further comprises transmitting, to the wireless network node, a feedback in response to the reception of the network signaling.

Preferably or in some embodiments, the measurement gap indication is triggered a time delay after the transmission of the feedback.

Preferably or in some embodiments, the time delay is N milliseconds or M slots which is determined based on a sub-carrier spacing of a resource for the measurement operation.

Preferably or in some embodiments, the measurement gap indication is triggered for a valid period.

Preferably or in some embodiments, the network signaling comprises information associated with an adapted time length of the adopted measurement gap.

Preferably or in some embodiments, the network signaling comprises information associated with an adapted periodicity of the adopted measurement gap.

Preferably or in some embodiments, the network signaling indicates an adapted configuration from a list of configured measurement gaps.

Preferably or in some embodiments, triggering the measurement gap indication for adapting the measurement gap comprises:

triggering the measurement gap indication for adapting the measurement gap if an entering condition of triggering an event is met.

Preferably or in some embodiments, the entering condition of triggering the event is associated with at least one of:
measurement results of a serving cell,
measurement results of a neighbor cell, or
a mobility state of the wireless terminal.

Preferably or in some embodiments, the entering condition comprises:
a signal quality measurement result is an offset higher than a configured threshold during a time period.

Preferably or in some embodiments, the signal quality measurement result comprises a reference signal received power or a signal to interference and noise ratio.

Preferably or in some embodiments, triggering the measurement gap indication for adapting the measurement gap if the entering condition of triggering the event is met comprises:
transmitting, to the wireless network node, event triggered information or information of the adapted measurement gap if the entering condition of the event is met.

Preferably or in some embodiments, the measurement gap indication is triggered a time delay after transmitting the event triggered information or the information of the adapted measurement gap.

Preferably or in some embodiments, the wireless communication method further comprises deactivating the measurement gap indication if a leaving condition of the event is met.

Preferably or in some embodiments, the leaving condition of the event is associated with at least one of:
measurement results of a serving cell,
measurement results of a neighbor cell, or
a mobility state of the wireless terminal.

Preferably or in some embodiments, the wireless communication method further comprises transmitting, to the wireless network node, leaving event information if the leaving condition of the event is met.

Preferably or in some embodiments, triggering the measurement gap indication for adapting the measurement gap comprises at least one of:
decreasing a time length of the measurement gap,
increasing a periodicity of the measurement gap, or
canceling the measurement gap in a time period.

Preferably or in some embodiments, decreasing the time length of the measurement gap comprise at least one of:
halving the time length of the measurement gap, or
configuring a part of slots configured by the configuration information for the measurement gap.

Preferably or in some embodiments, triggering the measurement gap indication for adapting the measurement gap comprises: prioritizing a data transmission over a measurement in the measurement gap.

Preferably or in some embodiments, the wireless communication method further comprises transmitting, to the wireless network node, data in a disabled part of the measurement gap configured by the configuration information via the measurement gap indication.

Preferably or in some embodiments, the wireless communication method further comprises receiving, from the wireless network node, pre-configured resource information for a data transmission in the measurement gap configured by the configuration information.

The present disclosure relates to a wireless communication method for use in a wireless network node. The method comprises:
transmitting, to a wireless terminal, configuration information associated with a measurement gap, and
transmitting, to the wireless terminal, a network signaling for adapting the measurement gap configured based on the configured information.

Various embodiments may preferably implement the following features:

Preferably or in some embodiments, the network signaling is a media access control element.

Preferably or in some embodiments, the wireless communication method further comprises receiving, from the wireless terminal, feedback in response to the transmission of the network signaling.

Preferably or in some embodiments, the measurement gap adaption is activated a time delay after a transmission of the feedback.

Preferably or in some embodiments, the time delay is N milliseconds or M slots which is determined based on a sub-carrier spacing of a resource for a measurement operation performed in the measurement gap.

Preferably or in some embodiments, the measurement gap adaption is triggered for a valid period.

Preferably or in some embodiments, the network signaling comprises information associated with an adapted time length of the adopted measurement gap.

Preferably or in some embodiments, the network signaling comprises information associated with an adapted periodicity of the adopted measurement gap.

Preferably or in some embodiments, the network signaling indicates an adapted configuration from a list of configured measurement gaps.

Preferably or in some embodiments, the network signaling is transmitted based on a reception of an uplink channel, a reception of an uplink signal, a measurement result in a period.

Preferably or in some embodiments, adapting the measurement gap comprises at least one of:
decreasing in a time length of the measurement gap,
increasing a periodicity of the measurement gap, or
canceling the measurement gap in a time period.

Preferably or in some embodiments, decreasing the time length of the measurement gap comprise at least one of:
halving the time length of the measurement gap, or
configuring a part of slots configured by the configuration information for the measurement gap.

Preferably or in some embodiments, adapting the measurement gap comprises prioritizing a data transmission over a measurement in the measurement gap.

Preferably or in some embodiments, the wireless communication method further comprises transmitting or receiving, data in a disabled part of the measurement gap configured by the configuration information via the measurement gap indication.

Preferably or in some embodiments, the data is transmitted or received outside of the adapted measurement gap.

Preferably or in some embodiments, the wireless communication method further comprises transmitting, to the wireless terminal, pre-configured resource information for a data transmission in the measurement gap configured by the configuration information.

The present disclosure relates to a wireless terminal. The wireless terminal comprises:
a communication unit, configured to receive, from a wireless network node, configuration information associated with a measurement gap, and
a processor, configured to:
trigger a measurement gap indication for adapting the measurement gap configured by the configuration information, and perform a measurement operation based on the adopted measurement gap.

Various embodiments may preferably implement the following feature:

Preferably or in some embodiments, the processor is further configured to perform any of the aforementioned wireless communication methods.

The present disclosure relates to wireless network node. The wireless network node comprises:
a communication unit, configured to:
transmit, to a wireless terminal, configuration information associated with a measurement gap, and
transmit, to the wireless terminal, a network signaling for adapting the measurement gap configured based on the configured information.

Various embodiments may preferably implement the following feature:

Preferably or in some embodiments, the wireless network node further comprises a processor configured to perform any of the aforementioned wireless communication methods.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The invention is specified by the independent claims. Preferred embodiments are defined in the dependent claims. In the following description, although numerous features may be designated as optional, it is nevertheless acknowledged that all features comprised in the independent claims are not to be read as optional.

The above and other aspects and their implementations are described in greater detail in the drawings, the descriptions, and the claims.

### BRIEF DESCRIPTION OF THE DRAWINGS

FIG. 1 shows a schematic diagram of the measurement gap.

FIG. 2 shows a schematic diagram of patterns of configuration of Measurement gap length (MGL) and Measurement gap repetition period (MGRP) according to an embodiment of the present disclosure.

FIG. 3 shows a schematic diagram of receiving signaling of adoption of measurement gap according to an embodiment of the present disclosure.

FIG. 4 shows a schematic diagram of reducing the number of OFDM symbols/slots for performing measurement within the measurement period according to an embodiment of the present disclosure.

FIG. 5 shows a schematic diagram of a network architecture according to an embodiment of the present disclosure.

FIG. 6 shows an example of a schematic diagram of a wireless terminal according to an embodiment of the present disclosure.

FIG. 7 shows an example of a schematic diagram of a wireless network node according to an embodiment of the present disclosure.

FIG. 8 shows a flowchart of a method according to an embodiment of the present disclosure.

FIG. 9 shows a flowchart of a method according to an embodiment of the present disclosure.

### DETAILED DESCRIPTION

The extended Reality (XR), such as AR (Augmented Reality) or VR (Virtual Reality), techniques arise in multiple use cases, e.g., immersive gaming, Smart Transport, collaborative and concurrent engineering, etc. From a wireless connection perspective, these use cases are supposed to be supported in an enhanced NR (new radio) wireless network, which requires properties of good capacity with both high data rate and low network latency. For certain XR services, the mobility requirement is low. That is a user who wears XR gadgets basically moves with a low velocity or even stays at a localized space. Under such conditions, the neighbor cell measurement (e.g., RRM requirement) may not be critical.

If neighbor measurement (e.g., RRM requirement) is not critical and the time gap for the neighbor measurement is refrained from data scheduling, the time resource in the time gap is considered as wasted. Consequently, the resource utilization efficiency would be low.

Thus, the present disclosure provides methods for measurement of gap adaption and a device thereof, e.g., to increase the resource utilization efficiency

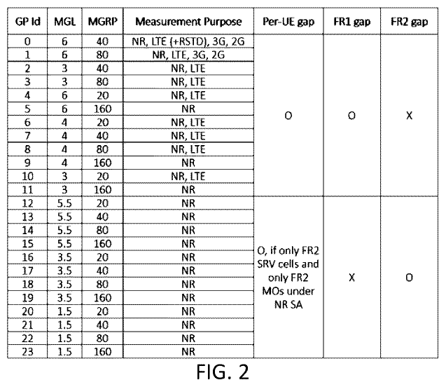

FIG. 2 shows a schematic diagram of patterns of configuration of Measurement gap length (MGL) and Measurement gap repetition period (MGRP) according to an embodiment of the present disclosure. In an embodiment, any one of 23 measurement gap Patterns shown in FIG. 2 may be configured to an XR UE for the neighbor measurement.

In some embodiments, the Network adapts measurement gap via a MAC/DCI (media access control/downlink control) signaling trigger or via an event trigger. For example, the UE is allowed to have flexible measurement gaps for the neighbor measurement, e.g., to activate partial slots/or symbols of old MG, to change Measurement gap repetition period, or to de-activate measurement gap. Under such conditions, certain measurement gap(s) is reduced or cancelled and the time resource corresponding to the reduced/canceled measurement(s) is allowed to be scheduled for data transmission or reception. Therefore, the resource utilization becomes more efficient. In addition, the handover performance may be slightly affected.

### Adaption of Measurement Gap Triggered Via Network Signaling

In an embodiment, the UE receives, from the network, a network signaling which triggers the measurement gap adaption. For example, the network signaling may be a MAC CE (media access control control element), DCI (downlink control information) or an RRC (radio resource control signaling).

In an embodiment, a DCI format signaling, a new bit field within a DCI format, or a new MAC CE is received at the UE side. When the UE (successfully) receives the indication, the UE provides feedback to the DCI format signaling or MAC CE indication and the adaption of the measurement gap is activated.

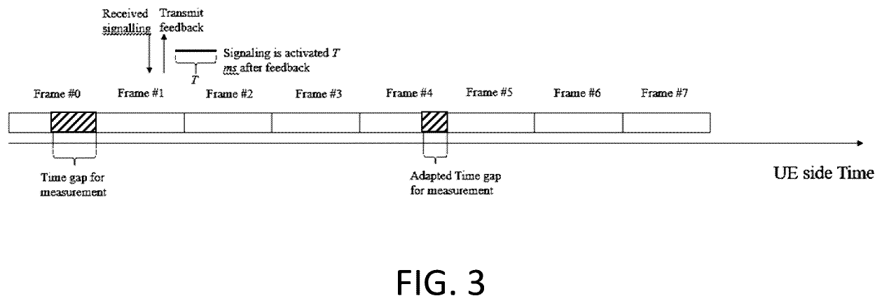

FIG. 3 shows a schematic diagram of receiving signaling of adoption of measurement gap according to an embodiment of the present disclosure. In FIG. 3, the signaling is activated T ms after the UE transmitting positive feedback. That is the configuration of new/updated/adopted measurement gap is used no earlier than a time offset/delay (e.g., T1 ms) after the UE transmitting the positive feedback. Note that, in FIG. 3, the time gap for the measurement (i.e., measurement gap) at the frame #4 is updated/adopted/adjusted to be half of the length of old measurement gap.

In an embodiment, the adaption of measurement gap is valid and/or used within a designated time duration (e.g., T2 ms), e.g., after receiving the network signaling or transmitting the positive feedback.

In an embodiment, the adaption of measurement gap is valid and/or used within a time duration (e.g., T2 ms) which is a time offset/delay (e.g., T1 ms) after the UE transmitting the positive feedback Moreover, these two embodiments can be combined at the same time.

In an embodiment, the signaling is activated T3*2u slots after the UE transmitting the positive feedback, wherein u is associated with a SCS (sub-carrier spacing) of an active BWP in the serving cell. That is the time offset/delay between the transmission of the positive feedback and the activation/trigger of the adaptation of the measurement gap may be represented in the unit of slot. In an embodiment, u=0, if SCS=15 kHz; u=1, if SCS=30 kHz; u=2, if SCS=60 kHz; u=3, if SCS=120 kHz; u=5, if SCS=480 kHz; or u=6, if SCS=960 kHz.

In an embodiment, the indication allows the UE to adapt the measurement gap. For instance, the indication allows/indicates/instructs the UE to activate partial slots and/or symbols of old/original measurement gap, to change Measurement gap repetition period, to de-activate measurement gap, etc.

In an embodiment, based on the indication, the UE may increase the measurement period.

In an embodiment, for each GP ID (see FIG. 2), the MGRP of a configuration can be increased up to one value of (40, 80, 160, 320). In this embodiment, the indication of value of the MGRP can be a 2-bits signaling.

For instance, the MGRP corresponding to the GP Id 0 in FIG. 2 can be (increased from 40 to) 80. That is the UE performing the measurement based on the measurement configuration corresponding to the GP Id 0 in FIG. 2 may increase the MGRP to 80. In another example, the MGRP corresponding to the GP Id 10 can be set as 40 based on the adaption of the measurement gap configuration.

In an embodiment, the indication allows the UE to activate/de-activate partial slots/or symbols in the measurement gap. For example, based on the indication, the UE may reduce the number of OFDM symbols/slots for performing measurement within the measurement period.

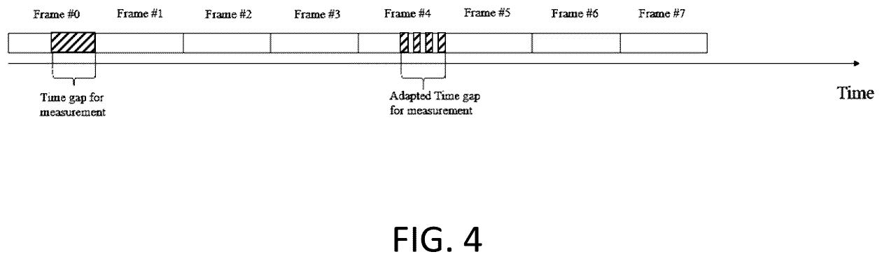

FIG. 4 shows a schematic diagram of reducing the number of OFDM symbols/slots for performing measurement within the measurement period according to an embodiment of the present disclosure. In FIG. 4, partial slots in the measurement gap are configured as time gap for measurement. In other words, (total) Measurement Gap Length (MGL) can be reduced.

In an embodiment, the slot with an odd slot index is configured as the adapted measurement gap. As an alternative, the slot with the even slot index is configured as the adapted measurement gap.

In an embodiment, partial slots in original measurement gap and/or continuous/contiguous slots are configured as the adapted measurement gap.

Furthermore, the indication of adaption of MGL can be 2 bits, wherein indicates 4 patterns of updated/reduced/adopted measurement gap. For example, the 4 patterns of updated/reduced/adapted measurement gap may comprise:
only slots with odd slot indexes in the measurement gap are configured as the updated/reduced/adapted measurement gap (e.g., used for measurement);
only slots with even slot indexes in the measurement gap are configured as the updated/reduced/adapted measurement gap;
first half continuous/contiguous slots in the measurement gap are configured as the updated/reduced/adapted measurement gap; and
second half continuous/contiguous slots in the measurement gap are configured as the updated/reduced/adapted measurement gap.

### Condition of Network Signaling Trigger

In an embodiment, a DCI signaling trigger can be based on the UL channel/signal reception, measurement, decoding at the BS side.

In another embodiment, the DCI signaling trigger can be based on measurement and report of severing cell from the UE. For example, the UE performs the (inter-frequency) neighbor cell measurements and reports the measurement results to the BS. Based on the measurement results, if determining that the communication quality of the UE in the serving cell is good (e.g., if the RSRP is an offset higher than a configured threshold during a time period), the BS may transmit the DCI as the signaling trigger of the measurement gap adaption.

In an embodiment, multiple measurement gap patterns are configured via an RRC signaling and at least one gap pattern is the reduced measurement gap pattern. Moreover, the values of the MGRP and the MGL at the last MG period before the indication of adaption are taken as reference MG for subsequent adaption.

Adaption of Measurement Gap Triggered Via Event Trigger or Via UL UCI/MAC CE from UE Side

In an embodiment, the signaling (e.g., UL UCI/MAC CE) from the UE Side for triggering the adaption of the measurement gap is activated T1 ms after the UE transmitting the signaling.

In an embodiment, the adaption of measurement gap is valid and used within a time duration (e.g., T2 ms), e.g., after the transmission of the signaling or the event trigger.

In an embodiment, the adaption of measurement gap is valid and used within a time duration (e.g., T2 ms) which is T1 ms after the transmission of the signaling or the event trigger.

In some embodiments, the entering condition of a defined event at the UE side is met/fulfilled, which triggers the adaptation of the measurement gap.

In an embodiment, a new event X-1 (e.g., similar to event A1 in current specification), the new event denotes that measurement of neighbor cell can be reduced.

For example, the event X-1 is triggered when/if an entering condition is met. In an embodiment, the entering condition is that a measurement result of the serving cell is good and satisfy an Event threshold. If the entering condition is met and the event X-1 is triggered the UE reports the event X-1 to the gNB, for the purpose of not measuring the neighbor cell(s).

In an embodiment, the UE performs inter-frequency neighbor cell measurement and report the measurement results to the gNB. If the serving cell is good, e.g., the RSRP/SINR (reference signal received power/signal to interference and noise ratio) is an offset higher than a configured threshold during a time period, the entering condition is met and thus the event X-1 is triggered.

In an embodiment, when/if the entering condition is met, the event X-1 is triggered. The entering condition is associated with/based on the measurement results of the serving cell and/or neighbor cell.

In an embodiment, when/if an entering condition is met, the event X-1 is triggered. In this embodiment, the entering condition is associated with or based on a judgement of the mobility of the UE, e.g., whether a velocity of the UE is lower than a threshold, or whether the velocity of the UE is 0.

In an embodiment, when/if a leaving condition is met, the event X-1 is ended.

In another case, the when event X-1 is trigger, UE can activate partial slots/or symbols of old MG, change Measurement gap repetition period, de-activate measurement gap etc.

In another embodiment, UE can postpone the measurement gap in old configuration,

In additional embodiment, UE can improve the priority of linked LCH for data transmission over its neighbor cell measurement.

In an embodiment, the leaving condition of a defined event at UE side is triggered, which triggers measurement gap adaption (inverse case).

Define a new event X-2, which denotes that the measurement gap of neighbor cell can be increased. For example, in case of mobility of XR devices, the RRM requirement is tight, at least the pre-configured measurement gap pattern can be applied, or the measurement gap can be further increased.

Specially, if the serving cell is poor (e.g., the RSRP/SINR is an offset lower than a configured threshold during a time period), the leaving condition is met, and the event X-2 is triggered.

In some embodiment, the UE reports its selection and/or decision.

In an embodiment, the UE informs the BS that the event X-1 has been triggered, e.g., via high layer signaling,

In an embodiment, the UE may inform the BS about the selection/decision of the UE, e.g., the information of activated partial slots/or symbols, the changed Measurement gap repetition period, etc.

In an embodiment, the UE may inform the BS about the decision of de-activating the measurement gap

In an embodiment, the UE may inform the BS that that the UE postpones the measurement gap in a configuration, e.g., for a time duration.

In an embodiment, the UE may inform that BS that the BS has higher priority of scheduling linked LCH (logic channel) for the data transmission over allowing the UE to perform neighbor cell measurement in the measurement gap.

In some embodiments for a DL transmission, the network may pre-configure resources for data transmissions in the original measurement gap via an SPS (semi-persistent scheduling) configuration.

In an embodiment for SPS parameter, a periodicity can be set as same as the MGRP.

If the event X-1 is triggered or if the network signaling trigger indicates the UE to adapt the measurement gap, the pre-configured resource can be activated for the data transmission. In contrast, if the event X-1 is inactivated or is not triggered or if the network signaling trigger indicates the UE not to adapt the measurement gap, the pre-configured resources are not activated, and the measurement is performed during the original measurement gap.

In an embodiment for the UL transmission, the network may pre-configure resources for the data transmission in the original measurement gap via a CG configuration.

In an embodiment for CG parameter, a periodicity can be the same as the MGRP.

Similar as the DL cases, if the event X-1 is triggered or if the network signaling trigger indicates the UE to adapt the original measurement gap, the pre-configured resource can be activated for the data transmission.

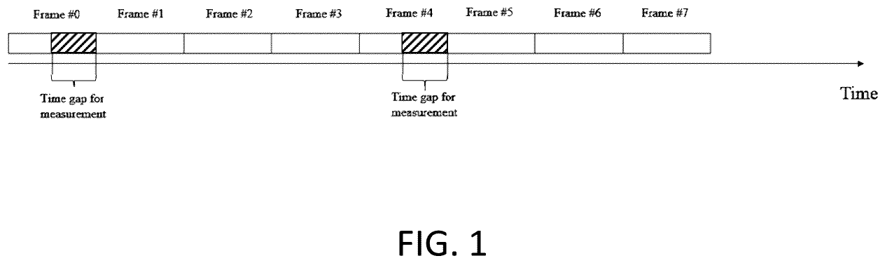

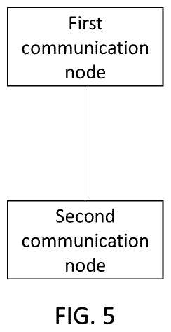

FIG. 5 shows a schematic diagram of a network (architecture) according to an embodiment of the present disclosure. The network (architecture) shown in FIG. 1 comprises a first communication node and a second communication node. The first communication node may be a UE, a wireless terminal, a wireless device, etc. The second communication node may be a BS, a gNB, an eNB, a repeater, a relay and so on.

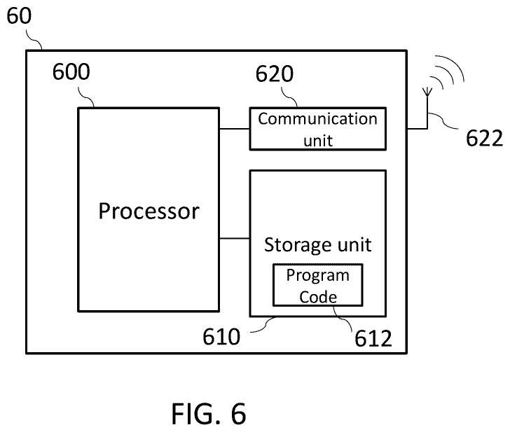

FIG. 6 relates to a schematic diagram of a wireless terminal 60 according to an embodiment of the present disclosure. The wireless terminal 60 may be a user equipment (UE), a mobile phone, a laptop, a tablet computer, an electronic book or a portable computer system and is not limited herein. The wireless terminal 60 may include a processor 600 such as a microprocessor or Application Specific Integrated Circuit (ASIC), a storage unit 610 and a communication unit 620. The storage unit 610 may be any data storage device that stores a program code 612, which is accessed and executed by the processor 600. Embodiments of the storage unit 610 include but are not limited to a subscriber identity module (SIM), read-only memory (ROM), flash memory, random-access memory (RAM), hard-disk, and optical data storage device. The communication unit 620 may a transceiver and is used to transmit and receive signals (e.g., messages or packets) according to processing results of the processor 600. In an embodiment, the communication unit 620 transmits and receives the signals via at least one antenna 622 shown in FIG. 6.

In an embodiment, the storage unit 610 and the program code 612 may be omitted and the processor 600 may include a storage unit with stored program code.

The processor 600 may implement any one of the steps in exemplified embodiments on the wireless terminal 60, e.g., by executing the program code 612.

The communication unit 620 may be a transceiver. The communication unit 620 may as an alternative or in addition be combining a transmitting unit and a receiving unit configured to transmit and to receive, respectively, signals to and from a wireless network node (e.g., a base station).

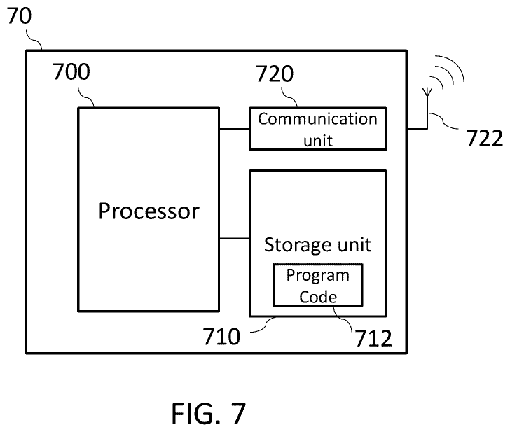

FIG. 7 relates to a schematic diagram of a wireless network node 70 according to an embodiment of the present disclosure. The wireless network node 70 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 70 may comprise (perform) at least one network function such as an access and mobility management function (AMF), a session management function (SMF), a user place function (UPF), a policy control function (PCF), an application function (AF), etc. The wireless network node 70 may include a processor 700 such as a microprocessor or ASIC, a storage unit 710 and a communication unit 720. The storage unit 710 may be any data storage device that stores a program code 712, which is accessed and executed by the processor 700. Examples of the storage unit 710 include but are not limited to a SIM, ROM, flash memory, RAM, hard-disk, and optical data storage device. The communication unit 720 may be a transceiver and is used to transmit and receive signals (e.g., messages or packets) according to processing results of the processor 700. In an example, the communication unit 720 transmits and receives the signals via at least one antenna 722 shown in FIG. 7.

In an embodiment, the storage unit 710 and the program code 712 may be omitted. The processor 700 may include a storage unit with stored program code.

The processor 700 may implement any steps described in exemplified embodiments on the wireless network node 70, e.g., via executing the program code 712.

The communication unit 720 may be a transceiver. The communication unit 720 may as an alternative or in addition be combining a transmitting unit and a receiving unit configured to transmit and to receive, respectively, signals to and from a wireless terminal (e.g., a user equipment or another wireless network node).

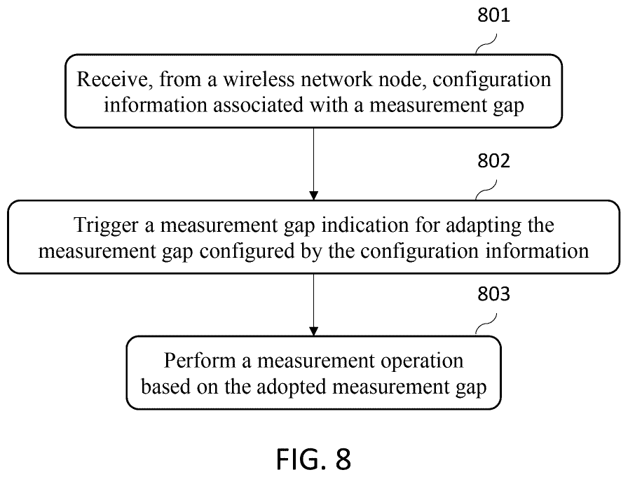

FIG. 8 shows a schematic diagram of a method according to an embodiment of the present disclosure. The method shown in FIG. 8 may be used in a wireless terminal (e.g., UE) and comprises the following steps:

Step 801: Receive, from a wireless network node, configuration information associated with a measurement gap.

Step 802: Trigger a measurement gap indication for adapting the measurement gap configured by the configuration information.

Step 803: Perform a measurement operation based on the adopted measurement gap.

In FIG. 8, the wireless terminal receives configuration information associated with a measurement gap from a wireless network node (e.g., BS). In this embodiment, the wireless terminal may trigger a measurement gap indication, to adapt the measurement gap configured by the configuration information. The wireless terminal then performs a measurement operation based on the adopted measurement gap.

In an embodiment, the measurement gap in a first period is not canceled after being adapted. In this embodiment, the wireless terminal performs a measurement in the adapted measurement gap in the first period.

In an embodiment, the measurement gap in a second period is canceled after being adapted. Under such conditions, the wireless terminal skips the measurement in the second period.

In an embodiment, the wireless terminal receives a network signaling of triggering the measurement gap indication (e.g., triggering the adaption of the measurement gap).

In an embodiment, the network signaling is a MAC CE.

In an embodiment, the wireless terminal transmits feedback in response to the reception of the network signaling. In this embodiment, the measurement gap indication (or the adaption of the measurement gap) is triggered a time delay after the transmission of the feedback.

In an embodiment, the time delay is N milliseconds or M slots, wherein N and M are determined based on a sub-carrier spacing of a resource for the measurement operation.

In an embodiment, the measurement gap indication is triggered for a valid period.

In an embodiment, the network signaling comprises at least one of:
information associated with an adapted time length of the adopted measurement gap,
information associated with an adapted periodicity of the adopted measurement gap, or
(an indication of) an adapted configuration from a list of configured measurement gaps.

In an embodiment, if an entering condition of triggering an event is met, the wireless terminal triggers the measurement gap indication for adapting the measurement gap. That is the measurement gap indication (or the adoption of the measurement gap) may be event-trigger.

In an embodiment, the entering condition of triggering the event is associated with at least one of:
measurement results of a serving cell,
measurement results of a neighbor cell, or
a mobility state (e.g., a moving speed) of the wireless terminal.

For example, the entering condition may be/comprise a signal quality measurement result (e.g., RSRP or SINR) is an offset higher than a configured threshold during a time period.

In an embodiment of the entering condition of triggering the event is met, the wireless terminal transmits event triggered information and/or information of the adapted measurement gap to the wireless network node. In this embodiment, the measurement gap indication (or the adaption of the measurement gap) is triggered a time delay after the transmission of the event triggered information or the information of the adapted measurement gap. In an embodiment, the event triggered information may indicate that the event is triggered.

In an embodiment, the measurement gap indication may be deactivated if a leaving condition of the event is met or fulfilled.

In an embodiment, the leaving condition of the event is associated with at least one of:
measurement results of a serving cell,
measurement results of a neighbor cell, or
a mobility state of the wireless terminal.

In an embodiment of the leaving condition of the event met or fulfilled, the wireless terminal transmits laving event information to the wireless network node. For example, the leaving event information indicates that the event (i.e., the adaption of the measurement gap) is deactivated.

In an embodiment, the wireless terminal may adapt the measurement gap by at least one of:
decreasing a time length of the measurement gap,
increasing a periodicity of the measurement gap, or
canceling the measurement gap in a time period.

In an embodiment, the wireless terminal decreases the time length of the measurement gap by at least one of:
halving the time length of the measurement gap, or
configuring a part of slots configured by the configuration information for the measurement gap.

In an embodiment, the wireless terminal may adapt the measurement gap by prioritizing a data transmission over a measurement in the measurement gap.

In an embodiment, the wireless terminal may transmit, via the measurement gap indication, data in a disabled part of the measurement gap (originally) configured by the configuration information.

In an embodiment, the data is transmitted outside of the adapted measurement gap (in the originally configured measurement gap).

In an embodiment, the wireless terminal receives pre-configured resource information for a data transmission in the measurement gap configured by the configuration information.

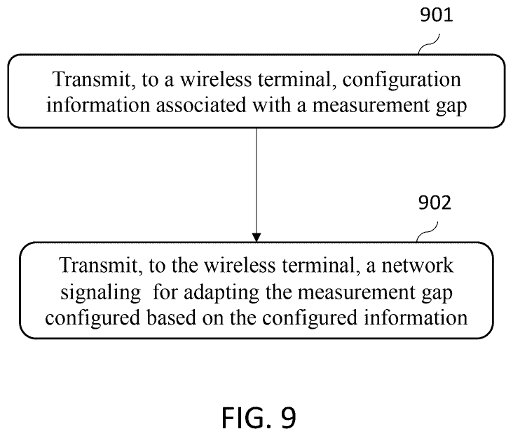

FIG. 9 shows a flowchart of a method according to an embodiment of the present disclosure. The method shown in FIG. 9 may be used in a wireless network node (e.g., BS) and comprises the following steps:

Step 901: Transmit, to a wireless terminal, configuration information associated with a measurement gap.

Step 902: Transmit, to the wireless terminal, a network signaling for adapting the measurement gap configured based on the configured information.

In FIG. 9, the wireless network node transmits configuration information to a wireless terminal (e.g., UE) for configuring a measurement gap. In this embodiment, the wireless network node further transmits a network signaling to the wireless terminal, to adapt the measurement gap configured by the transmitted configuration information.

In an embodiment, the network signaling is a MAC CE.

In an embodiment, the wireless network node receives feedback in response to the transmission of the network signaling from the wireless terminal. The measurement gap adaption may be activated/valid a time delay after a transmission of the feedback.

In an embodiment, the time delay is N milliseconds or M slots which is determined based on a sub-carrier spacing of a resource for the measurement operation.

In an embodiment, N and M is determined based on a sub-carrier spacing of a resource for a measurement operation performed in the measurement gap.

In an embodiment, the measurement gap adaption is triggered for a valid period.

In an embodiment, the network signaling comprises at least one of:
information associated with an adapted time length of the adopted measurement gap;
information associated with an adapted periodicity of the adopted measurement gap; or
(an indication of) an adapted configuration from a list of configured measurement gaps.

In an embodiment, the network signaling is transmitted based on a reception of an uplink channel, a reception of an uplink signal, a measurement result in a period.

In an embodiment, the measurement gap may be adapted by at least one of:
decreasing in a time length of the measurement gap,
increasing a periodicity of the measurement gap, or
canceling the measurement gap in a time period.

In an embodiment, the time length of the measurement gap may be decreased by at least one of:
halving the time length of the measurement gap, or
configuring a part of slots configured by the configuration information for the measurement gap.

In an embodiment, the measurement gap may be adapted by prioritizing a data transmission over a measurement in the measurement gap.

In an embodiment, the wireless network node may transmit, to the wireless terminal, data in a disabled/adapted part of the measurement gap configured by the configuration information via the measurement gap indication. As an alternative, the wireless network node may receive, from the wireless terminal, data in the disabled/adapted part of the measurement gap configured by the configuration information via the measurement gap indication.

For example, the data is transmitted or received outside of the adapted measurement gap (and in the measurement gap originally configured by the configuration information). If the measurement gap is canceled in a period, the data may be transmitted in the canceled measurement gap.

In an embodiment, the wireless network node may transmit, to the wireless terminal, pre-configured resource information for a data transmission in the measurement gap configured by the configuration information.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

What is claimed is:

1. A wireless communication method for use in a wireless terminal, the wireless communication method method comprising:
receiving, from a wireless network node, configuration information associated with a measurement gap, and
triggering a measurement gap indication for adapting the measurement gap configured by the configuration information.

2. The wireless communication method of claim 1, further comprising at least one of:
performing a measurement in the adopted measurement gap in a first period if the adopted measurement gap is not canceled in the first period, or
skipping a measurement in a second period.

3. The wireless communication method of claim 1, further comprising:
receiving, from the wireless network node, a network signaling of triggering the measurement gap indication.

4. The wireless communication method of claim 3, wherein the network signaling is a downlink control information (DCI).

5. The wireless communication method of claim 1, wherein a DCI format signaling or a new bit field within a DCI format is received by the wireless terminal.

6. A wireless communication method for use in a wireless network node, the wireless communication method comprising:
transmitting, to a wireless terminal, configuration information associated with a measurement gap, and
transmitting, to the wireless terminal, a network signaling for adapting the measurement gap configured based on the configured information.

7. The wireless communication method of claim 6, wherein the network signaling is configured to trigger a measurement gap indication.

8. The wireless communication method of claim 6, wherein the network signaling is a downlink control information (DCI).

9. The wireless communication method of claim 6, wherein a DCI format signaling or a new bit field within a DCI format is received by the wireless terminal.

10. A wireless terminal, comprising:
a communication unit, configured to receive, from a wireless network node, configuration information associated with a measurement gap, and
at least one processor, configured to:
trigger a measurement gap indication for adapting the measurement gap configured by the configuration information.

11. The wireless terminal of claim 10, wherein the at least one processor is further configured to at least one of:
perform a measurement in the adopted measurement gap in a first period if the adopted measurement gap is not canceled in the first period, or
skip a measurement in a second period.

12. The wireless terminal of claim 10, wherein the at least one processor is further configured to receive, from the wireless network node, a network signaling of triggering the measurement gap indication.

13. The wireless terminal of claim 12, wherein the network signaling is a downlink control information (DCI).

14. The wireless terminal of claim 10, wherein a DCI format signaling or a new bit field within a DCI format is received by the wireless terminal.

15. A wireless network node, comprising:
a communication unit, configured to:
transmit, to a wireless terminal, configuration information associated with a measurement gap, and
transmit, to the wireless terminal, a network signaling for adapting the measurement gap configured based on the configured information.

16. The wireless communication method of claim 15, wherein the network signaling is configured to trigger a measurement gap indication.

17. The wireless network node of claim 15, wherein the network signaling is a downlink control information (DCI).

18. The wireless network node of claim 15, wherein a DCI format signaling or a new bit field within a DCI format is received by the wireless terminal.
